(19) United States
(12) Patent Application Publication
(10) Pub. No.: US 2026/0175190 A1
(43) Pub. Date: Jun. 25, 2026

(54) DOPED GOETHITE NANOPARTICLES FOR REGENERATIVE ADSORPTION, A METHOD FOR SAID ADSORPTION, AND USE OF SAID NANOPARTICLES

(71) Applicant: AQUACARE EUROPE B.V., Hertogenbosch (NL)

(72) Inventors: Carlo BELLONI, LEEUWARDEN (NL); Leendert Date KORVING, LEEUWARDEN (NL); Achim Iulian DUGULAN, LEEUWARDEN (NL); Geert Jan WITKAMP, LEEUWARDEN (NL); Ekkehard Hubertus BRÜCK, LEEUWARDEN (NL)

(21) Appl. No.: 19/127,603

(22) PCT Filed: Nov. 10, 2023
(86) PCT No.: PCT/NL2023/050594

§ 371 Date: May 6, 2025

(30) Foreign Application Priority Data
Nov. 10, 2022 (NL) 2033501

(51) Int. Cl. B01J 20/06; B01D 15/20; B01J 20/02; B01J 20/30; B01J 20/32; B01J 20/34; C02F 1/00; C02F 1/28; C02F 101/10

(52) U.S. Cl. CPC B01J 20/06; B01D 15/203; B01J 20/0244; B01J 20/3028; B01J 20/3078; B01J 20/3236; B01J 20/3433; B01J 20/3475; C02F 1/008; C02F 1/288; C02F 1/281; C02F 2101/103; C02F 2101/105; C02F 2209/18; C02F 2303/16; C02F 2305/08

(57) ABSTRACT

The invention relates to a doped goethite nanoparticles for regenerative adsorption, a method for regenerative adsorption of moieties comprising phosphorous and/or arsenic, use of said doped goethite nanoparticles, and an aqueous stream treated with said method. The doped goethite nanoparticles for regenerative adsorption comprising iron and a different transition metal, wherein proportionally to iron, the different transition metal is present in the doped goethite in the atomic percentage range of 1% at to 20% at doping.

The present invention relates to a doped goethite nanoparticles for regenerative adsorption, a method for regenerative adsorption of moieties comprising phosphorous and/or arsenic, use of said doped goethite nanoparticles, and an aqueous stream treated with said method.

Phosphorus (P) recovery is fundamental for one or more of the following reasons. First, it is an irreplaceable and vital nutrient, essential to the world food production sustainability, and its demand will further increase due to population growth. Second, phosphorous is a finite and non-renewable resource which comes from phosphate rock mines, with reserves available in only a few countries, and therefore limited availability, asking for a more circular nutrients and resources management. Third, through agricultural runoff and wastewater treatment-plant (WWTP) effluents, phosphorous reaches surface waterbodies where it accumulates, and becomes a pollutant, causing several environmental, health and socio-economic issues.

Compounds comprising phosphorous in water can be found both in organic and/or inorganic forms, and particulate and/or solute state (i.e., phosphate), the latter being the bioavailable compound comprising phosphorous fraction causing eutrophication and promoting algae bloom, which entails severe environmental, health and socio-economic damages. To prevent eutrophication, compound comprising phosphorous concentrations in freshwater bodies needs to be limited to ultra-low concentrations, below 0.02 mg L⁻¹, which is hundred times lower than current regulations for WWTP effluents (usually between 1 mg L⁻¹ to 2 mg L⁻¹).

Arsenic (As) removal is fundamental as it is a highly toxic (e.g., possibly carcinogenic) element. It may reach freshwater reservoirs through human activities (e.g., mining activities) and natural phenomena (e.g., soil, sediments, and mineral leaching in groundwaters. Compounds comprising arsenic in water can be found both in organic and/or inorganic forms, and particulate and/or solute state (i.e., arsenate, arsenite). The presence of arsenic in water is harmful already at concentrations above 0.05 mg L⁻¹. It is preferred to treat arsenic containing waters down to below 0.05 mg L⁻¹ for drinking water. Arsenic can be recovered to be then immobilized or possibly reused, as it can be applied in the glass or semiconductor industries (among others).

Therefore, it is important to remove compounds comprising phosphorous and/or arsenic from water, as well as to recover it to be reused, following a circular approach.

Conventional techniques for removing of compounds comprising phosphorous and/or arsenic are based on for example precipitation and/or one time adsorption, which are therefore expensive and do not allow regeneration of the precipitate and/or adsorbents.

These problems prevent an efficient and effective recovery from compounds comprising phosphorous and/or arsenic. This problem is even bigger for large scale recovery from compounds comprising phosphorous and/or arsenic.

The present invention aims at obviating or at least reducing the aforementioned problems and to enable efficient and effective adsorption and recovery of compounds comprising phosphorous and/or arsenic.

This objective is achieved with doped goethite nanoparticles for regenerative adsorption comprising iron and a different transition metal, wherein the different transition metal proportionally to iron is present in the doped goethite in the atomic percentage range of 1% at to 20% at doping.

It is noted that goethite refers to the iron mineral, consisting of an iron oxyhydroxide containing ferric iron, specifically the α polymorph α-FeOOH.

The doped goethite nanoparticles according to the invention provide stability of the goethite nanoparticle and are therefore suitable for regeneration and thus a longer lifespan of the adsorbent. In addition, in comparison to ‘normal’ goethite nanoparticles, the doped goethite nanoparticles according to the invention are more efficient and effective. Furthermore, it was found that the doped goethite nanoparticles according to the invention show potential to adsorb phosphorous and/or arsenic.

The potential of using doped goethite nanoparticles according to the invention to adsorb phosphorous and/or arsenic is linked to the higher phosphorous and/or arsenic loading (capacity) at low equilibrium concentrations, with respect to other iron oxide and/or iron hydroxide species, even compared to ferrihydrite, which has a higher surface area. This fact is also supported by the higher affinity that the doped goethite nanoparticles according to the invention display towards phosphate and/or arsenic, compared to other iron oxide and/or iron hydroxide species, such as ferrihydrite. Furthermore, ferrihydrite nanoparticles are generally unstable and tend to dissolve and/or transform during regeneration. Therefore, doped goethite nanoparticles according to the invention show efficient and effective adsorption of moieties comprising phosphorous and/or arsenic.

It is noted that moieties comprising phosphorous and/or arsenic may refer to compounds, molecules, and/or ions, such as anions, comprising phosphorous and/or arsenic. In particular water soluble moieties.

The efficient and effective adsorption of moieties comprising phosphorous and/or arsenic with the doped goethite nanoparticles according to the invention may be explained by the charge imbalance due to the substitution of iron by the different transition metal in goethite which is compensated by protonation of the different transition metal site. This results in an overall higher protonation of the doped goethite nanoparticles according to the invention in water. Furthermore, the elongation of the doped goethite nanoparticles according to the invention, which have promoted the growth of crystal faces with higher active adsorption sites density, results in a more effective surface.

A further advantage of the doped goethite nanoparticle according to the invention is that the environmental impact of the moieties comprising phosphorous and/or arsenic is reduced, as well as the excipients to remove said moieties comprising phosphorous and/or arsenic.

Furthermore, the doped goethite nanoparticle according to the invention enables a circular approach, and thus a circular environment. It is noted that circular relates to the re-use of compounds/additives/resources and the like in order to remove and/or regenerate moieties comprising phosphorous and/or arsenic. Said re-use includes that the compounds/additives/resources are used in a similar or same manner as before. Thus, without degradation of said material.

Yet a further advantage of the doped goethite nanoparticle according to the invention is that said nanoparticle in a wet (suspended) form is non-toxic. Therefore, an operator does not need to take severe safety precautions when using the doped goethite nanoparticles when they are wet (in suspended form) according to the invention. Furthermore, the treated stream, such a wastewater, does not need to be chemically treated to reduce the amount of moieties comprising phosphorous and/or arsenic. Thus, an economically viable nanoparticle suitable for removing and/or recovering moieties comprising phosphorous and/or arsenic is achieved.

A further advantage of the doped goethite nanoparticles according to the invention is that said nanoparticles may be regenerated for at least 50 times, wherein the activity of said nanoparticles is reduced by at most 30% compared to first time use.

The adsorption of moieties comprising phosphorous and/or arsenic may be by binding of the phosphorous and/or arsenic comprising species with the doped goethite nanoparticles via any one of a covalent bond, ionic interaction or dipolar bond.

As used herein, “transition metal” is meant to include any element in the d-block of the periodic table, which includes groups 3 to 12 on the periodic table. Iron being one of said transition elements, the term “different transition metal” refers to any transition metal from the aforementioned group, different from iron.

In a presently preferred embodiment according to the invention, the different transition metal may be a divalent transition metal and/or a trivalent transition metal.

It was found that a divalent transition metal and/or a trivalent transition metal as different transition metal provides an efficient and effective doped goethite nanoparticles for regenerative adsorption.

In a further presently preferred embodiment according to the invention, the different transition metal may be one or more selected from the group of molybdenum, cobalt, chromium, zinc, preferably the different transition metal may be zinc, more preferably wherein the different transition metal is divalent zinc.

An advantage of the doped goethite nanoparticle wherein said goethite nanoparticle is doped with zinc enables an efficient and effective regenerative adsorption of moieties comprising phosphorous and/or arsenic. In addition, doping the goethite nanoparticle with zinc provides a cast effective adsorbent for moieties comprising phosphorous and/or arsenic.

In a further presently preferred embodiment according to the invention, the different transition metal in the doped goethite may be proportionally present to iron in the atomic percentage range of 1% at to 15% at doping, preferably in the atomic percentage range of 1% at to 10% at doping, more preferably in the atomic percentage range of 2% at to 10% at doping, even more preferably in the atomic percentage range of 2.5% at to 7.5% at doping.

It was found that 2.5% at to 7.5% at, preferably 5% at, is an optimum percentage for doping of the goethite nanoparticle with a different transition metal, preferably zinc, to boost the phosphorous recovery performances. Furthermore, the doping with said transition metal percentage, preferably zinc, lead to an increase in the point of zero charge of the goethite nanoparticles.

In addition, it was found that a 2.5% at to 7.5% at, preferably 5% at, doped goethite nanoparticle was able to remove about 25% more phosphorous per mass of adsorbent compared to the pure goethite nanoparticles (goethite nanoparticles which are not doped with a different transition metal). Furthermore, a 2.5% at to 7.5% at doped goethite nanoparticle provides an optimal phosphorous removal performance compared to other ranges.

In a further presently preferred embodiment according to the invention, the ratio between iron and the different transition metal in the doped goethite may be 30:1, 25:1, 20:1, 15:1, 10:1, or 5:1.

The ratio between iron and the different transition metal in the doped goethite according to the invention enables an efficient and effective adsorption of moieties comprising phosphorous and/or arsenic.

In a further presently preferred embodiment according to the invention, the doped goethite nanoparticle further comprises a solid support, wherein the doped goethite nanoparticles are embedded on the solid support, preferably wherein the solid support may be one or more selected from the group of resin, zeolite, porous ceramic, gel.

In a preferred embodiment, the solid support comprises one or more of a charged polymeric media and neutral polymeric media.

Providing the doped goethite nanoparticle according to the invention to a solid support enables to fixate said nanoparticles and concentrates the adsorbent. Therefore, less material is flushed away, and the majority of the doped goethite nanoparticles may be regenerated. In addition, providing the doped goethite nanoparticles according to the invention to a solid support enables to have a high concentration of said nanoparticles in a relatively small volume. The stream, such as wastewater may therefore be efficiently and effectively treated, wherein the majority of the moieties comprising phosphorous and/or arsenic, preferably the dissolved moieties comprising phosphorous and/or arsenic, is removed and trapped/captured/absorbed by said nanoparticles.

The doped goethite nanoparticles according to the invention, were found particularly useful in adsorbing a moiety comprising phosphorous and/or arsenic, preferably wherein the moiety is one or more selected from the group of phosphate, phosphite, arsenate, arsenite. Preferably, the phosphate is an ortho-phosphate.

It was found that the doped goethite nanoparticles according to the invention are in particular an effective adsorbent for phosphate, phosphite, arsenate, and/or arsenite.

In a preferred embodiment, the moiety comprising phosphorous and/or arsenic, preferably wherein the moiety is one or more selected from the group of phosphate, phosphite, arsenate, arsenite, originates from a dissolved moiety comprising phosphorous and/or arsenic.

The invention also relates to a method for regenerative adsorption of moieties comprising phosphorous and/or arsenic, comprising the steps of:
contacting an aqueous stream comprising the moieties comprising phosphorous and/or arsenic, and doped goethite nanoparticles according to the invention with each other;
adsorbing the moieties comprising phosphorous and/or arsenic by the doped goethite nanoparticles;
recovering the moieties comprising phosphorous and/or arsenic from the doped goethite nanoparticles; and
regenerating the doped goethite nanoparticles.

The method for regenerative adsorption of moieties comprising phosphorous and/or arsenic provides the same effects and advantages as those described for the doped goethite nanoparticles for regenerative adsorption according to the invention.

The method according to the invention may start with the step of contacting an aqueous stream comprising the moieties comprising phosphorous and/or arsenic, and doped goethite nanoparticles according to the invention with each other. Said step may be followed by the step of adsorbing the moieties comprising phosphorous and/or arsenic by the doped goethite nanoparticles. The latter step may be performed until the doped goethite nanoparticles are saturated, whereafter the step of recovering the moieties comprising phosphorous and/or arsenic from the doped goethite nanoparticles may be performed. The step of recovering may be followed by the step of regenerating the doped goethite nanoparticles.

The method according to the invention may, particularly, be used for regenerative adsorption of moieties comprising phosphorous and/or arsenic which are dissolved in the aqueous stream. As a result, the aqueous stream may be efficiently and effectively treated, such that the concentrations of phosphorous and/or arsenic are lowered/reduced to a minimum.

For example, the moieties comprising phosphorous and/or arsenic solubilised in an aqueous stream and/or solid particles comprising phosphorous and/or arsenic in the aqueous stream may be removed by the method according to the invention, wherein the method further may comprise the step of filtering. Said step of filtering may reduce the amount of solid particles, including particles comprising phosphorous and/or arsenic, in the aqueous stream.

In other words, the step of adsorbing the moieties comprising phosphorous and/or arsenic by the doped goethite nanoparticles includes the step of adsorbing dissolved moieties comprising phosphorous and/or arsenic.

A further advantage of the method according to the invention is that said method may be operated in a continuous or semi-continuous mode. Furthermore, the method according to the invention may operate autonomous or semi-autonomous.

In a presently preferred embodiment according to the invention, the moieties comprising phosphorous and/or arsenic comprises one or more selected from the group of phosphate, phosphite, arsenate, arsenite, preferably the moieties comprising phosphorous and/or arsenic may be a phosphate comprising compound.

In a preferred embodiment, the moiety comprises phosphorous, preferably wherein the moiety comprises phosphate and/or phosphite.

It was found that the doped goethite nanoparticles according to the invention are, in particular, an effective adsorbent for phosphate, phosphite, arsenate, and/or arsenite.

A further advantage of adsorbing phosphate is that the quality of the aqueous stream is increased and thus eutrophication due to a surplus of phosphorous sources is reduced or eliminated.

In a preferred embodiment the step of regenerating the doped goethite nanoparticle includes washing with an alkaline solution. Said alkaline solution may regenerate the adsorbent by removing the moieties comprising phosphorous and/or arsenic from the surface of the doped goethite nanoparticles.

In a further presently preferred embodiment according to the invention, the doped goethite nanoparticles may be regenerated for at least 80% of the initial amount, preferably for at least 85% of the initial amount, more preferably for at least 90% of the initial amount.

It is noted that the percentage of regeneration of the doped goethite nanoparticles refers to the available adsorption sited of the doped goethite nanoparticles according to the invention. In other words, the absorption capacity of the doped goethite nanoparticles according to the invention after regeneration is at least 80%, preferably at least 85%, more preferably at least 90%, compared to the initial absorption capacity of (virgin) doped goethite nanoparticles according to the invention.

It was found that the step of regenerating enables regenerating the doped goethite nanoparticles according to the invention for at least 80% of the initial amount, preferably for at least 85% of the initial amount, more preferably for at least 90% of the initial amount. This enables an efficient and effective method for regenerative adsorption of a moiety comprising phosphorous and/or arsenic.

In addition, it was found that the step of regenerating the doped goethite nanoparticles may be performed up to 50 times or more.

In a further presently preferred embodiment according to the invention, the method further comprises the step of measuring the content of the moieties comprising phosphorous and/or arsenic in the aqueous stream, preferably the step of measuring the content of the moieties comprising phosphorous and/or arsenic precedes the step of recovering the moieties comprising phosphorous and/or arsenic from the doped goethite nanoparticles.

The step of measuring the content of the moieties comprising phosphorous and/or arsenic enables to timely change the doped goethite nanoparticles according to the invention. Furthermore, said step enables to tune/monitor the concentration of moieties comprising phosphorous and/or arsenic in the aqueous stream. If said concentration exceeds a threshold, the adsorbing may be stopped and recovering may be performed.

For example, if a threshold is exceeded the aqueous stream may be provided to another tank such that (fresh) doped goethite nanoparticles may be contacted with the aqueous stream. The doped goethite nanoparticles according to the invention which have adsorbed the moieties comprising phosphorous and/or arsenic may then be exposed to the step of recovering and the step of regenerating.

In a further presently preferred embodiment according to the invention, the steps of recovering and regeneration may be performed when the content of the moieties comprising phosphorous and/or arsenic is higher than 250 μg L⁻¹, preferably 150 μg L⁻¹, more preferably 50 μg L⁻¹, even more preferably higher than 40 μg L⁻¹, even more preferably higher than 30 μg L⁻¹, even more preferably higher than 20 μg L⁻¹, most preferably higher than 10 μg L⁻¹.

The threshold to change/renew the doped goethite nanoparticles according to the invention may include a content higher than 250 μg L⁻¹, preferably 150 μg L⁻¹, more preferably 50 μg L⁻¹, even more preferably higher than 40 μg L⁻¹, even more preferably higher than 30 μg L⁻¹, even more preferably higher than 20 μg L⁻¹, most preferably higher than 10 μg L⁻¹. In other words, when the content in the aqueous stream after the step of adsorbing exceeds said threshold, the step of recovering and/or regenerating may be performed.

Thus, the lower limit according to the invention is 0 μg L⁻¹. In other words, the aqueous stream is substantially fully purified/treated and substantially all moieties comprising phosphorous and/or arsenic are removed.

In a preferred embodiment, the steps of recovering and regeneration may be performed when the content of the dissolved moieties comprising phosphorous and/or arsenic is higher than the abovementioned concentrations.

In a further presently preferred embodiment according to the invention, wherein the doped goethite nanoparticles may be embedded on a solid support.

Embedding the doped goethite nanoparticles on a solid support enables an efficient and effective method for regenerative adsorption of moieties comprising phosphorous and/or arsenic. This also enables to circulate the aqueous stream, such that said stream passes multiple times the same and/or different doped goethite nanoparticles embedded on a solid support.

The invention also relates to the use of doped goethite nanoparticles according to the invention for removal of moieties comprising phosphorous and/or arsenic from an aqueous stream, preferably wherein the aqueous stream is a fresh water aqueous stream.

The doped goethite nanoparticles according to the invention provides the same effects and advantages as those described for the doped goethite nanoparticles for regenerative adsorption according to the invention, and the method for regenerative adsorption of moieties comprising phosphorous and/or arsenic according to the invention.

It was found that the doped goethite nanoparticles and method according to the invention are in particular effective for treating (fresh) surface water, water from lakes, general wastewater, industrial wastewater and the like.

In preferred embodiment the doped goethite nanoparticles are embedded on a solid support.

The invention also relates to an aqueous stream treated with the method according to the invention, comprising a content of moieties comprising phosphorous and/or arsenic of at most 250 μg L⁻¹, preferably at most 100 μg L⁻¹, more preferably at most 50 μg L⁻¹, even more preferably at most 40 μg L⁻¹, even more preferably at most 30 μg L⁻¹, even more preferably at most 20 μg L⁻¹, most preferably at most 10 μg L⁻¹.

The aqueous stream treated with the method according to the invention provides the same effects and advantages as those described for the doped goethite nanoparticles for regenerative adsorption according to the invention, the method for regenerative adsorption of moieties comprising phosphorous and/or arsenic according to the invention, and use of the doped goethite nanoparticles according to the invention.

It is noted that said concentrations are the result after exposure of the aqueous stream to the adsorbent.

It was found that the aqueous stream treated with the method according to the invention may efficiently and effectively comprise a content of moieties comprising phosphorous and/or arsenic of at most 50 μg L⁻¹.

Thus, the lower limit according to the invention is 0 μg L⁻¹. In other words, the aqueous stream is substantially fully purified/treated and substantially all moieties comprising phosphorous and/or arsenic are removed.

In a preferred embodiment, the pre-treated aqueous stream comprises a content of moieties comprising phosphorous and/or arsenic of at most 10 mg L⁻¹, preferably at most 8 mg L⁻¹, more preferably at most 5 mg L⁻¹, even more preferably at most 2 mg L⁻¹.

It is noted that the pre-treated aqueous stream is the aqueous stream provided in the step of contacting an aqueous stream comprising the moieties comprising phosphorous and/or arsenic, and doped goethite nanoparticles according to the invention with each other.

Further advantages, features and details of the invention are elucidated on the basis of preferred embodiments thereof, wherein reference is made to the accompanying drawings, in which:

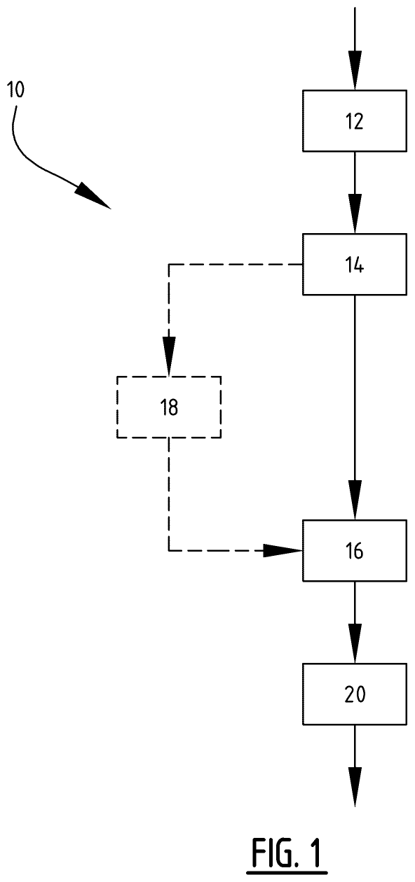

FIG. 1 shows a schematic overview of the method according to the invention;

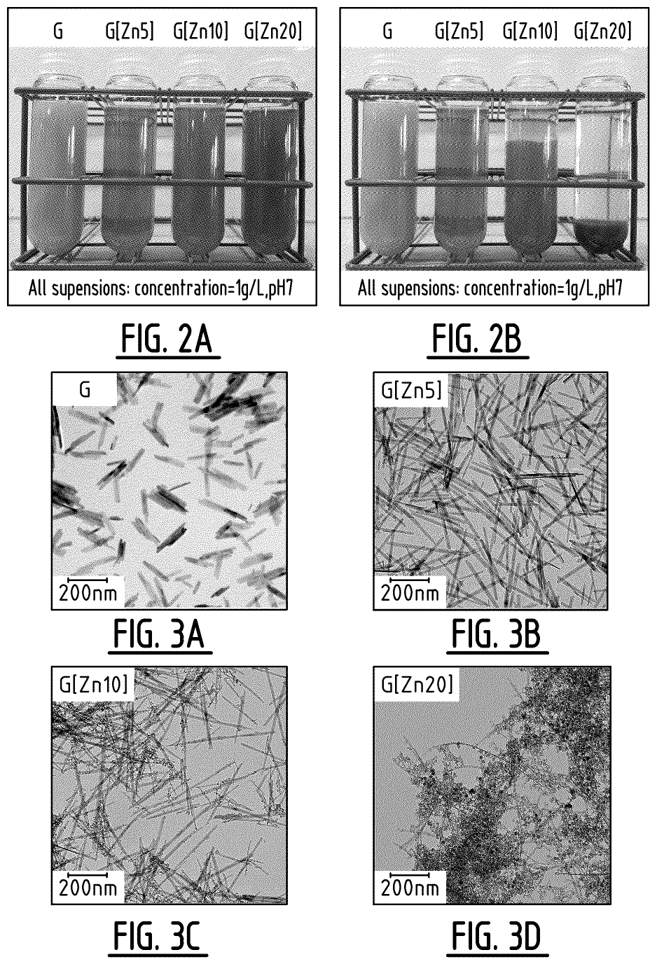

FIG. 2 shows different suspensions of synthesized doped nanoparticles;

FIG. 3 shows TEM imaging for the nanoparticles comprising different doping;

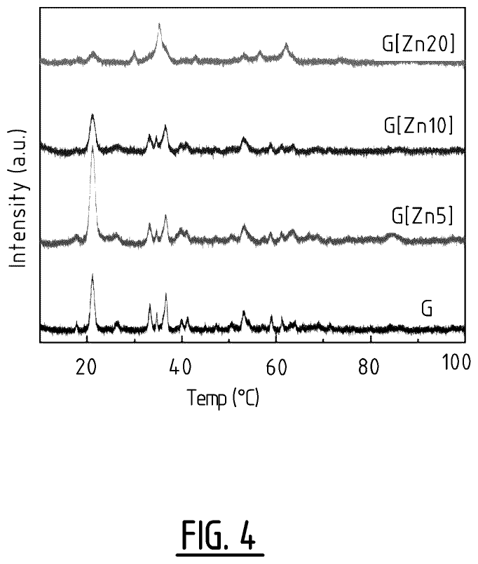

FIG. 4 shows X-ray diffraction spectra for the nanoparticles comprising different doping;

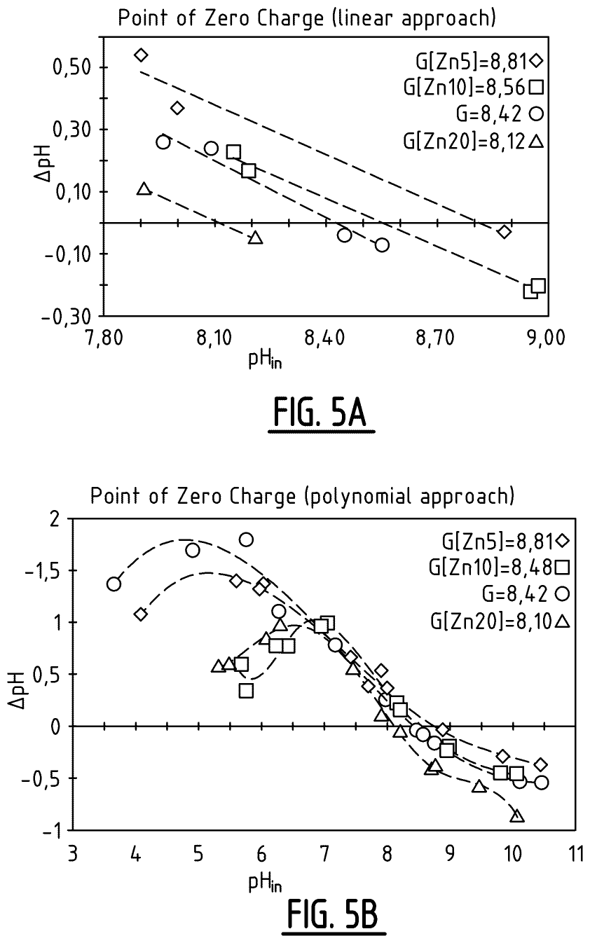

FIG. 5 shows the calculated ΔpH plotted against pHᵢₙ for the nanoparticles comprising different doping;

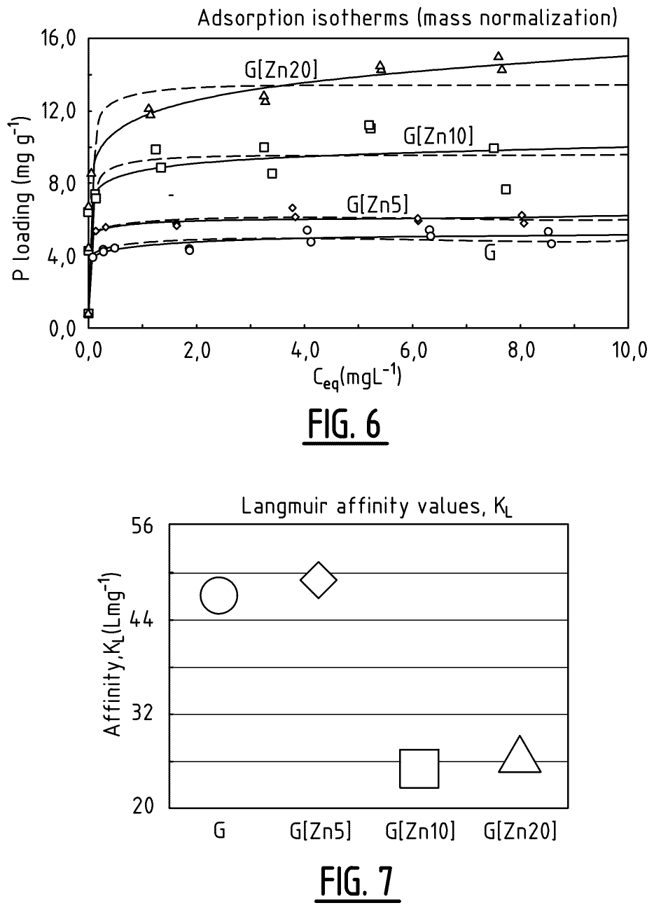

FIG. 6 shows the adsorption results graph normalized to the mass for the nanoparticles comprising different doping;

FIG. 7 shows the affinities for the nanoparticles comprising different doping; and

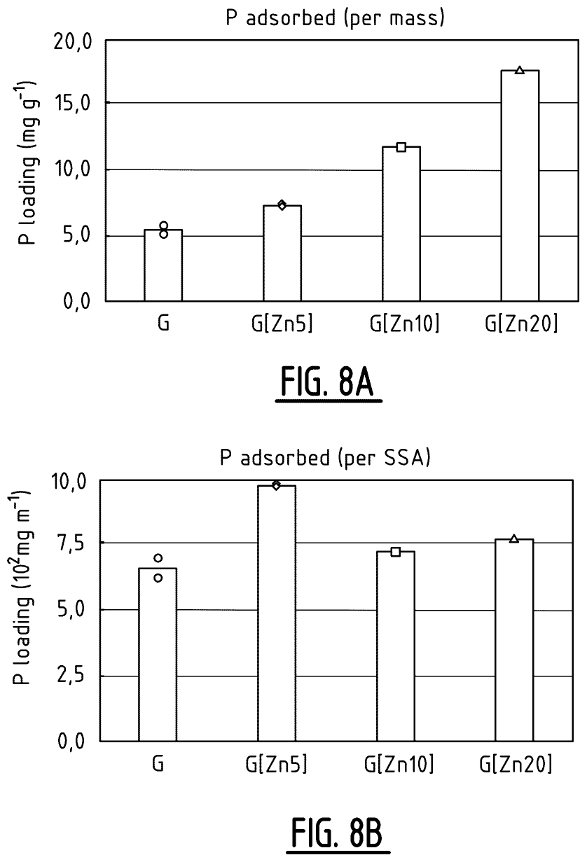

FIG. 8 shows the adsorption and desorption for the nanoparticles comprising different doping.

Method 10 (FIG. 1) for regenerative adsorption of moieties comprising phosphorous and/or arsenic, follows a sequence of steps. Furthermore, method 10 may preferably be performed in a continuous or semi-continuous mode. Thus, method 10 may be performed using a fixed bed column approach.

In the illustrated embodiment method 10 starts with step 12 of contacting an aqueous stream comprising the moieties comprising phosphorous and/or arsenic, and doped goethite nanoparticles according to the invention with each other. Step 12 is followed by step 14 of adsorbing the moieties comprising phosphorous and/or arsenic by the doped goethite nanoparticles.

Furthermore, step 14 may be followed by step 16 of recovering the moieties comprising phosphorous and/or arsenic from the doped goethite nanoparticles. Alternatively, step 14 may be followed by step 18 of further comprising the step of measuring the content of the moieties comprising phosphorous and/or arsenic in the aqueous stream, and step 16 of recovering the moieties comprising phosphorous and/or arsenic from the doped goethite nanoparticles. Preferably, step 18 and step 16 are performed in said order.

Step 16 is followed by step 20 of regenerating the doped goethite nanoparticles.

“ ”

### Chemicals

Potassium dihydrogen phosphate (KH₂PO₄), sodium chloride (NaCl), 1 M sodium hydroxide (NaOH), 1 M hydrochloric acid and 37% hydrochloric acid (HCl) were purchased at VWR (The Netherlands). 3-(N-morpholino) propane sulfonic acid (MOPS) and iron nitrate nonahydrate (Fe(NO₃)₃·9 H₂O) were obtained from Sigma-Aldrich (The Netherlands), and zinc nitrate hexahydrate (Zn(NO₃)₂·6 H₂O) from Alfa Aesar (Germany).

### Synthesis Doped Nanoparticles

The goethite nanoparticles were synthesized by the following procedure: CO₂-free Milli-Q water was prepared by overnight N₂-bubbling, to eliminate CO₂. Then, 50 g of Fe(NO₃)₃·9 H₂O was added to 825 g of the CO₂-free Milli-Q. In parallel, 200 ml of 2.5 M NaOH CO₂-free solution was prepared. The NaOH solution was then injected in the Fe solution at a controlled flow of 1 mL min⁻¹ through a peristaltic pump (Cole-Palmer, Masterflex L/S), to obtain consistent results and controlled size of the nanoparticles, under N₂ bubbling, 250 rpm stirring. Once NaOH addition was completed, the solution, now at pH>12, was let stirring for further 30 min. The solution consisted of a suspension of agglomerated ferrihydrite-based precipitates and was then placed in an oven at 60° C. for 48 h, occasionally shaking the suspension for homogeneity, to age the ferrihydrite into goethite. The phase transformation was visually confirmed by the suspension colour change, from a dark brown to ochre.

For the doped goethite nanoparticles, the same procedure was followed for consistency, with the difference of the Fe solution, which in this case consisted of a mixture of Fe salt and different transition metal (DTM) salt, preferably a Zn salt, in the DTM-5% at Fe., DTM-10% at Fe, and DTM-20% at Fe. Different transition metal to Fe ratio, for which the salts were weighed accordingly. When a Zn salt was used, after the aging, the colour changed from dark brown to dark red/purple, depending on the amount of Zn added.

Each synthesis provided around 8 g of doped goethite nanoparticle suspension. The doped goethite nanoparticle suspension was then filtered via Buchner filtration, obtaining the so-called doped goethite nanoparticle cake, which was first thoroughly rinsed with Milli-Q water, and then recovered, resuspended in demineralized water through thorough shaking and by 10 min sonication at 40 kHz (Bandelin, Sonorex RM16UH). Then, the pH was adjusted to around 7 (pH of interest for the adsorption experiments) using HCl and NaOH. The doped goethite nanoparticles were let to settle, and the supernatant was removed and replaced by demineralized water, followed by pH adjustment to 7. The washing procedure was repeated until the supernatant reached a conductivity below 0.1 μS cm⁻¹.

The synthesized samples are referred to as G for the pure goethite, and G[Zn5], G[Zn10] and G[Zn20] for the Zn-5% at Fe, Zn-10% at Fe, and Zn-20% at Fe. Thus, Zn to Fe ratio doped goethite nanoparticles.

### Nanoparticles Characterization

The nanoparticles were characterized combining several methods, to obtain a complete description of their features and properties.

The pH and conductivity of the nanoparticle suspensions were measured with a SevenExcellence pH/Cond meter S470, Mettler-Toledo.

The mass concentration in solution of the nanoparticles was estimated by weighing and oven-drying (60° C.) of a fixed volume of the suspensions.

To confirm the Zn to Fe % at in the doped goethite nanoparticles samples, an aliquot of the suspension was centrifuged, to remove the supernatant, dissolved in HCl 37% acid solutions, and analysed with a Perkin Elmer Optima 5300 DV Inductively Coupled Plasma Optical Emission Spectroscopy (ICP-OES, referred to as ICP for simplicity).

To observe the morphology of the synthesized nanoparticles, Transmission Electron Microscopy (TEM) measurements were performed with a JOEL JEM1400-plus with a TVIPS F416 camera operating at 120 kV. The data were analysed with ImageJ software to estimate the size of the nanoparticles. TEM-SAED (Selected Area Electron Diffraction) was also employed to investigate the crystallinity of the nanoparticles.

X-Ray Diffraction measurements provided information on the speciation of the NPs, as well as their crystalline structure and size. X-Ray Diffraction measurements were performed with a PANalytical X'Pert pro X-Ray diffractometer mounted in the Bragg-Brentano configuration with a Cu anode (0.4 mm×12 mm line focus, 45 KV, 40 mA). X-Ray scattered intensities were measured with a real-time multi strip (RTMS) detector (X'Celerator). The data were collected in the angle range 5°<2θ<90° with a step size of 0.008° (2θ); total measuring time was 1 h for all samples except G[Zn20%], which had a measuring time of 2 h. A spinner was used as a sample holder, to homogenize the results and avoid artifacts, such as increased intensity due to nanoparticles preferential arrangement during sample preparation. Spectra were analysed in fingerprinting mode using the X'Pert software.

“The point of zero charge is defined as the pH at which the net surface charge of the adsorbent is neutral and is an indirect measurement of the surface charge of the adsorbent. The point of zero charge was estimated using salt addition. In short, different 50 mL centrifuge tubes were prepared with 10 mL of 5 g L⁻¹ nanoparticles suspension adjusted at different initial pH in the range of 5 to 10, using NaOH and HCl. The samples were let to equilibrate in a shaking incubator (150 rpm, 25° C.) for at least 5 days. Then, the initial pH values, pHᵢₙ, were recorded, followed by 0.526 mL of 2 M NaCl solution addition (final NaCl concentration of 0.1 M). The samples were again let to equilibrate in a shaking incubator for at least a week. The final pH values, pH_{fin}, were recorded and the ΔpH=pH_{fin}−pHᵢₙ values calculated. Experiments were run in duplicates. Sample preparation and measurements took place in a glovebox with N₂ atmosphere, and all solutions and nanoparticles suspension where N₂-bubbled for several hours prior use, to prevent pH fluctuations due to CO₂ exchange with the solutions. The nanoparticles suspensions were also sonicated for 15 min before use. The point of zero charge corresponds to the pH value at which ΔpH=0, i.e., the pH value at which the plot ΔpH vs pHᵢₙ crosses the x-axis (pHᵢₙ). The point of zero charge was determined with two different approaches. The first, by interpolating the whole data sets with a polynomial curve that could better represent the trend over a wide range of data, identifying the pH value were the polynomial curve was crossing the x-axis. The second, by identifying the closest data at the opposite sides to the x-axis and interpolating them with a linear function. pH measurements provided maximum pH fluctuations around 0.20 (i.e., ±0.10) after pH adjustment (pHᵢₙ), and within 0.10 (i.e., ±0.05) after pH equilibrations (pH_{fin}), while the pH meter (handheld PH 20, VWR, with GE 114 WD electrode) had an accuracy of ±0.02. The root squared sum combinations of these contributions provided an uncertainty of ±0.11, which has been rounded up to ±0.15, to provide a larger range of confidence. The results have been discussed in relative terms, i.e., by comparing the results obtained for the different samples, rather than in absolute terms.

### Phosphate Adsorption Experiments

To perform phosphate adsorption experiments, KH₂PO₄ salt was used as a source of phosphate and all concentrations are reported in terms of phosphorous concentrations. A 500 mg L⁻¹ phosphorous (compound comprising phosphorous) stock solution in demineralized water was prepared, from which different dilutions were obtained, with phosphorous concentrations of 0.1 mg L⁻¹, 0.5 mg L⁻¹, 0.75 mg L⁻¹, 1 mg L⁻¹, 2.5 mg L⁻¹, 5 mg L⁻¹, 7.5 mg L⁻¹, and 10 mg L⁻¹ as starting concentrations (d_{dil} [mg L⁻¹]). Adsorption experiments were performed in duplicates plus blank, i.e., phosphorous solution without adsorbent as a control. To keep the pH constant during the adsorption experiments, 20 mM of MOPS was added as a pH buffer, and the pH value adjusted to around 7.2 using NaOH and/or HCl. Meanwhile, a nanoparticles suspension of 1 g L⁻¹ was prepared and sonicated for 10 min to promote the nanoparticles dispersion, and the concentration verified by weighing oven-dried volumes. Then, 10 mL of the phosphorous dilutions samples were removed (and analysed with ICP) and replaced with 10 mL of the nanoparticles suspension for the adsorption samples (final adsorbent concentration of 0.1 g L⁻¹), and with 10 mL demineralised water for the blank samples. This procedure was chosen for practical reasons. The samples were then placed in a shaking incubator at 25° C., 150 rpm. It was observed that the adsorption experiments reached equilibrium within two days. Nevertheless, some samples were further analysed after one week, as a further control, without showing any appreciable difference.

### Desorption/Regeneration Experiments

A regeneration experiment was run to assess the influence of doping on the ease of regeneration of the nanoparticles and their stability. The aim of this experiment is simply to assess how easily phosphate could desorb from the nanoparticles, and the stability of the nanoparticles. It is well known that metal oxide-based adsorbents can be easily regenerated via an alkaline wash, often using 0.1 M to 1 M NaOH, i.e., pH 13-14. Often, in studies with nanoparticles, the adsorption samples are centrifuged to separate the nanoparticles from the adsorption solution, and then redispersed and regenerated. However, centrifugation is known to promote irreversible agglomeration of the nanoparticles, which might cause phosphate blocking, while redispersion of nanoparticles can require long and harsh sonication which might alter the nanoparticles. In this study, the desorption was therefore performed by increasing the pH directly in the phosphorous solution after the adsorption equilibrium was reached, with the following procedure. First, an adsorption experiment was run similarly to the isotherm experiments, again in duplicates plus blank. From the phosphorous stock solution, 100 mL samples of phosphorous concentration of 25 mg L⁻¹, with 20 mM MOPS and pH 7.2 were prepared. Meanwhile, a 3 g L⁻¹ nanoparticles suspension was prepared and sonicated for 10 min, and the concentration verified as previously reported. Then, 10 mL of the phosphorous solutions were removed and analysed with ICP and replaced by 10 mL of the nanoparticles suspension solution for the adsorption samples (resulting in an adsorbent concentration of 0.3 g L⁻¹), and by 10 mL of demineralised water for the blanks. The samples were then placed in a shaking incubator at 25° C., 150 rpm. After five days, to be sure equilibrium was reached, 5 mL of the solution was collected and filtered for analysis and replaced with 5 mL of 1 M NaOH solution, which increased the pH to around 12.6. The samples were placed in a shaking incubator at 25° C., 150 rpm, for one day. Then, the solutions were filtered and analysed with the ICP. The adsorption/desorption samples were then centrifuged to recover the nanoparticles, which were then oven dried and analysed with Mössbauer spectroscopy. The regeneration pH was deliberately chosen to be low compared to the usual pH previously mentioned, in order to enhance the differences in desorption.

“““13hosphorous

In a first experiment, different suspensions of synthesized doped nanoparticles comprising 0% at zinc (left vial of FIG. 2A and FIG. 2B), 5% at zinc (second left vial of FIG. 2A and FIG. 2B), 10% at zinc (second right vial of FIG. 2A and FIG. 2B), and 20% at zinc (right vial of FIG. 2A and FIG. 2B), show different colours, as well as different settling behaviour after pH adjustment (FIG. 2). This shows that the dopants caused changes in the structure and properties of the nanoparticles. FIG. 2A show the suspensions at t=0 minutes, and FIG. 2B shows the suspensions at t=10 minutes (all suspension were at pH 7 and with a nanoparticles concentration of 1 g/L).

The pure goethite nanoparticles suspension is characterized by an ochre colour. With increasing Zn doping, the nanoparticles suspension turns more and more into a red/purple colour shade. The different colours show a correct inclusion of Zn within the goethite structure and a change of the (optical) properties.

Therefore, a change in properties of the goethite nanoparticles due to Zn doping. In particular, the surface properties are modified: the surfaces are differently charged at pH 7, and the “less charged” nanoparticles repel each other less, meaning said nanoparticles are less prone to remain in suspension and tend to settle.

Thus, FIG. 2A and FIG. 2B show a colour change in goethite due to increasing Zn doping, from ochre (typical of pure goethite) to a more and more red/purple colour. Moreover, goethite doping shows differences also in settling behaviour, therefore Zn doping influenced the goethite surface charge.

In a second experiment, ICP measurements of dissolved NPs (in HCl 37%) showed the Zn to Fe % at for all samples of the doped goethite nanoparticles according to the invention, as reported in the Table 1. From the Brunauer-Emmett-Teller analysis of the specific surface area measurements it was observed that the specific surface area followed the trend: G[Zn20]>G[Zn10]>G≳G[Zn5], as shown in Table 1, with G[Zn10] an specific surface area almost two times higher compared to G and G[Zn5], while G[Zn20] has a specific surface area of almost three times higher compared to G and G[Zn5].

TABLE 1
Theoretical and experimental doping % at from ICP analysis after
HCl dissolution, and specific surface area values from Brunauer-
Emmett-Teller analysis of the different nanoparticles' samples.

| | theoretical | experimental | specific surface area |
|---|---|---|---|
| Sample | Zn/Fe % at | Zn/Fe % at | [m² g⁻¹] |
| G | 0 | — | 84.7 ± 0.9 |
| G[Zn5] | 5 | 5.1 ± 0.3 | 76.0 ± 0.8 |
| G[Zn10] | 10 | 10.2 ± 0.5 | 165 ± 1 |
| G[Zn20] | 20 | 21 ± 1 | 231 ± 2 |

Furthermore, TEM imaging (FIGS. 3A to D) showed that the nanoparticles in sample G (FIG. 3-A) present a rod-like shape, with a certain degree of size distribution. For the doped samples, it is visible that the length of these rods increases with increasing doping, while the opposite trend is observed for the width, insofar they look like filaments in the G[Zn20] images (FIG. 3-D). While G[Zn5] (FIG. 3-B) appear to display one unique phase of elongated rod-shaped nanoparticles, G[Zn10] (FIG. 3-C) and G[Zn20] (FIG. 3-D) display a coexistence of multiple phases, with the former presenting a moderate amount of fine nanoparticles, while the latter presenting a consistent amount of fine nanoparticles and few small spherical nanoparticles. A clear particle size estimation from TEM images was not possible since the nanoparticles clustered together during sample preparation. However, a rough estimation was obtained from the analysis of TEM images with ImageJ, by mean of a gaussian distribution of the measured values of more than 200 nanoparticles per sample, and the values are reported in Table 2. For the rod-shaped nanoparticles it is visible how, with increasing doping, the average length increased from 102 nm up to 185 nm for G[Zn10] (164 nm for G[Zn20]), while the average width decreased from 11 nm down to 6 nm. For the spherical nanoparticles in sample G[Zn20], an average diameter of 13 nm was estimated.

TABLE 2
Particle size estimation of the nanoparticles samples from TEM imaging (FIGS. 3 A to D) using ImageJ.

| | Rod-shaped nanoparticles | | | | | | Spherical/cubic nanoparticles | | | |
|---|---|---|---|---|---|---|---|---|---|---|
| | Length [nm] | | | Width [nm] | | | Diameter/Side [nm] | | | Amorphous |
| Sample | Min | Max | Mean | Min | Max | Mean | Min | Max | Mean | nanoparticles |
| G | 11 | 305 | 102 ± 46 | 3 | 23 | 11 ± 3 | — | — | — | — |
| G[Zn5] | 12 | 330 | 115 ± 55 | 3 | 20 | 9 ± 3 | — | — | — | — |
| G[Zn10] | 25 | 468 | 185 ± 88 | 2 | 13 | 6 ± 2 | — | — | — | Small amount |
| G[Zn20] | 24 | 462 | 164 ± 77 | 1 | 13 | 6 ± 2 | 5 | 24 | 13 ± 4 | Significant |
| | | | | | | | | | | amount |

In a further experiment, the X-ray diffraction spectra have been analysed using the X'Pert software. The results showed a good agreement of both G (FIG. 4 bottom line) and G[Zn5] (FIG. 4 second line from bottom) with goethite, with the latter displaying some differences in the relative peak intensities, most likely due to the rods elongation and sites distortion caused by the Zn-for-Fe substitution. The spectrum from G[Zn10] (FIG. 4 third line from bottom) is also in agreement with the goethite phase, with broader peaks and a noisier signal ascribable to the thinner nature of the rods and the presence of fine nanoparticles, as observed with TEM. Differently from the previous ones, the X-ray diffraction spectrum of G[Zn20] (FIG. 4 top line) displays a different pattern, with even broader and noisier peaks. These features are clearly due to the presence of small spherical particles, and the very fine rods and consistent presence of fine nanoparticles, as observed with TEM. Despite that the analysis showed zinc ferrite (franklinite) as the dominant phase, the presence of goethite cannot be excluded, since TEM still showed the presence of the fine rods, and their peak pattern might still be convoluted or hidden below the zinc ferrite's one. This nosier spectrum with broad peaks makes phase identification challenging, due to X-ray diffraction analysis limitations when dealing with fine and/or amorphous nanoparticles.

Iin a further experiment, the calculated ΔpH (y-axis) has been plotted against pHᵢₙ (x-axis), and the data were fit with both the linear analysis methods (FIG. 5-A) and polynomial analysis methods (FIG. 5-B), as explained above. The respective estimated point of zero charge values (Table 3) from both approaches where in agreement, with the only exception of G[Zn10] (square symbol), which anyway showed a slight deviation (within the assigned error), with no influence on the observed trend: G[Zn5] (diamond symbol)>G[Zn10] (square symbol)>G>G[Zn20] (triangle symbol).

Thus, in this application the circle symbols in the figures refer to G, the diamond symbols refer to G[Zn5], the square symbols refer to G[Zn10], and the triangle symbols refer to G[Zn20].

TABLE 3
values of G (circle symbol), G[Zn5] (diamond
symbol), G[Zn10] (square symbol), and G[Zn20]
(triangle symbol) obtained from the polynomial and
the linear interpolation of the data.

| | point of zero charge | point of zero charge |
|---|---|---|
| Sample | (polynomial) | (linear) |
| G | 8.42 | 8.42 |
| G[Zn5] | 8.81 | 8.81 |
| G[Zn10] | 8.48 | 8.56 |
| G[Zn20] | 8.10 | 8.12 |

In FIG. 5-A the top line at a pHᵢₙ of 8.2 refers to G[Zn5], the second line from the top refers to G[Zn10], the third line from the top refers to G, and the bottom line refers to G[Zn20].

In FIG. 5-B the top line at a pHᵢₙ of 6.0 refers to G, the second line from the top refers to G[Zn5], the third line from the top refers to G[Zn20], and the bottom line refers to G[Zn10].

The fact that G[Zn5] displays the highest point of zero charge (Table 3 and FIG. 5) shows that its surface charge is more positive in the pH range of interest, i.e., pH 6 to 8. This translates in a surface with higher surface sites density and hence higher adsorption performances (surface-wise) compared to the other samples. It was surprisingly found that substituting Fe³⁺ in goethite with Zn²⁺, which has a lower preferential oxidation state and a lower Pauling's electronegativity (1.65) compared to Fe (1.85) promotes an overall higher surface charge. This may be explained by the charge imbalance due to Zn-for-Fe substitution in goethite is compensated by protonation of the Zn site. This results in an overall higher protonation of the doped goethite nanoparticles in water. Furthermore, the elongation of the doped goethite nanoparticles, which have promoted the growth of crystal faces with higher active adsorption sites density, results in a more effective surface.

In a further experiment, the adsorption was further analysed. FIG. 6 shows the adsorption results graph normalized to the mass, obtained by plotting q [mg g⁻¹] against C_{eq} [mg L⁻¹]. The graph shows both the replicates' data and the fitting isotherms, the Langmuir model (dashed lines) and the Freundlich model (solid lines), while the fitting parameters values are reported in Table 2. The bottom dashed line and solid line at 2 mg g⁻¹ correspond to G, the second from the bottom dashed line and solid line at 2 mg g⁻¹ correspond to G[Zn5], the third from the bottom dashed line and solid line at 2 mg g⁻¹ correspond to G[Zn10], the top dashed line and solid line at 2 mg g⁻¹ correspond to G[Zn20].

For G and G[Zn5], both models describe the adsorption trend in a proper manner. For sample G[Zn10] it is harder to assess whether a multistep adsorption mechanism is taking place, given the two different nanoparticles phases in G[Zn10], and both isotherms appear to reasonably describe the adsorption trend. For sample G[Zn20], a multistep adsorption or a Freundlich-like adsorption trend is visible, as expected by the presence of multiple nanoparticle phases. The Langmuir model clearly appears inadequate to describe the data. In general, it is possible to see that phosphate adsorption is increasing with increasing doping, and the respective qₘₐₓ and K_{F} values do follow this trend. In the case of samples G[Zn10] and G[Zn20], there is a higher specific surface area available, due to the presence of fine nanoparticles. It is interesting to notice that the affinities, KL, display the following trend: G[Zn5]>G>>G[Zn20]>G[Zn10] (FIG. 7) which shows that G[Zn5] has a stronger interaction towards phosphorous. Therefore, G[Zn5] is being able to efficiently remove phosphorous even at low concentrations compared to the other samples and/or conventional adsorbents. FIG. 7 shows on the x-axis from left to right the samples G, G[Zn5], G[Zn10], and G[Zn20], and point of zero charge on the y-axis KL.

Therefore, the high affinity of G[Zn5] may be explained due to the presence of Zn itself, as well as of the protonation and/or specific crystal faces growth mentioned for the point of zero charge.

In a further experiment the regeneration of the doper goethite nanoparticles has been tested. First an adsorption experiment was performed, with a phosphorous concentration of 25 mg L⁻¹ and an adsorbent concentration of 0.3 g L⁻¹. FIG. 8-A shows that the adsorption of phosphorous follows G[Zn20]>G[Zn10]>G[Zn5]>G, wherein the sample (x-axis) is plotted against the adsorbed phosphorous per mass of adsorbent (mg g⁻¹) (y-axis). The corresponding adsorption values and their relative specific surface area coverage percentage per sample, calculated considering a PO4³⁻ radius of 238 μm are provided in Table 4. The observed surface coverage trend was G[Zn5]>G[Zn20]>G[Zn10]>G, with the highest coverage observed for G[Zn5], up to 3.31%, which confirms what observed in the specific surface area normalized isotherm experiment, further corroborating the idea of a more effective specific surface area of G[Zn5] compared to the other samples.

The desorption is shown in FIG. 8-B and follows G[Zn10]>G[Zn20]>G[Zn5]>G, wherein the sample (x-axis) is plotted against the phosphorous (P) loading (10² mg m⁻²) (%) (y-axis).

TABLE 4
Amount of adsorbed phosphorous per mass of adsorbent
and relative surface coverage, and desorbed phosphorous
and relative surface hindrance of undesorbed phosphorous,
of samples G, G[Zn5]. G[Zn10] and G[Zn20].

| | Adsorption | | Desorption | |
|---|---|---|---|---|
| | phosphorous | % specific | phosphorous | % specific |
| | adsorbed in | surface area | desorbed | surface area |
| Sample | mg g⁻¹ | coverage | in % w/w | still covered |
| G | 5.4 ± 0.3 | 2.2 ± 0.1 | 65 ± 1 | 0.68 ± 0.07 |
| G[Zn5] | 7.27 ± 0.08 | 3.31 ± 0.04 | 71 ± 12 | 0.8 ± 0.4 |
| G[Zn10] | 11.7 ± 0.1 | 2.46 ± 0.02 | 80 ± 4 | 0.37 ± 0.09 |
| G[Zn20] | 17.5 ± 0.2 | 2.62 ± 0.03 | 80 ± 1 | 0.40 ± 0.02 |

It is noted that the desorption experiments were performed at a pH of 12.6. FIG. 8-B shows the desorbed phosphorous percentages for each sample, wherein the x-axis provides the sample and the y-axis provides the mg phosphorous desorbed over the mg phosphorous adsorbed, which values are also provided in Table 4. The desorption results show that, on average, phosphorous desorption increased with increasing doping, or at least it was in the same order of magnitude of that of pure G, following a trend: G[Zn20]≳G[Zn10]>G[Zn5]≳ G. The undesorbed fraction caused a surface coverage from a minimum of 0.37% for G[Zn10], to a maximum value of 0.8% for G[Zn5]. These results show the high recovery of phosphorous for the doped samples, already at a pH of 12.6. Therefore, the Zn-doping did not affect the phosphorous binding mechanism, such as creating stronger bonds, other complexes or phases (surface precipitates), which would require more effort to be desorbed. Further investigation on the phosphorous recovery potential and regenerability of the nanoparticles is needed.

In addition, after the adsorption-desorption cycle, all samples have been analyzed with Mössbauer spectroscopy, to determine the stability and any possible change in the structure and phase of the doped nanoparticles, related to the whole process, as well as to the sample preparation.

It was found that sample G did not show much difference.

The Hf of sample G[Zn5] changed from 24.6 T to 25.6 T. The difference between the initial Hf of sample G[Zn5] and Hf after use is caused by crystallite growth, and may be overcome to provide the doped goethite nanoparticle to a solid support.

Mössbauer spectroscopy of sample G[Zn10] display similar features to that of the fresh sample of G[Zn10]. It was found that some of the fine nanoparticles contributing to the significant superparamagnetic relaxation features observed in the fresh samples went through crystallite growth and/or went lost during sample preparation.

Furthermore, Mössbauer spectroscopy of G[Zn20] showed similar results to G[Zn10].

Thus, throughout the adsorption-desorption cycle, G and G[Zn5] appeared to remain stable, as no significant phase changes have been observed in the Mössbauer analysis of the regenerated samples. The small differences are likely to be ascribed to improved crystallinity and crystallite growth, due to the different environmental condition to which the nanoparticles were exposed, both during the regeneration and the sample preparation. G[Zn10] displayed slight changes, due to improved crystallinity as well as what appears to be fine nanoparticles loss. Differently, G[Zn20] displayed consistent differences, due to either consistent dissolution/recrystallization of zinc ferrite nanoparticles and/or fine nanoparticles loss.

The present invention is by no means limited to the above described preferred embodiments and/or experiments thereof. The rights sought are defined by the following claims within the scope of which many modifications can be envisaged.

1. Doped goethite nanoparticles for regenerative adsorption, the doped goethite nanoparticles comprising iron and a different transition metal, wherein proportionally to iron, the different transition metal is present in the doped goethite nanoparticles in an atomic percentage range of 1% at to 20% at doping.

2. The doped goethite nanoparticles of claim 1, wherein the different transition metal is at least of one a divalent transition metal and a trivalent transition metal.

3. The doped goethite nanoparticles of claim 1, wherein the different transition metal is at least one of molybdenum, cobalt, chromium, and zinc.

4. The doped goethite nanoparticles of claim 3, wherein the different transition metal is zinc.

5. The doped goethite nanoparticles of claim 1, wherein the different transition metal proportionally to iron, is present in the doped goethite nanoparticles in an atomic percentage range of 1% at to 15% at doping.

6. The doped goethite nanoparticles of claim 1, wherein a ratio between iron and the different transition metal in the doped goethite is 30:1.

7. The doped goethite nanoparticles of claim 1, further comprising a solid support, wherein the doped goethite nanoparticles are embedded on the solid support.

8. The doped goethite nanoparticles of claim 7, wherein the solid support is at least one of resin, zeolite, porous ceramic, and gel.

9. The doped goethite nanoparticles of claim 1, further comprising a moiety comprising at least one of phosphorous and arsenic.

10. The doped goethite nanoparticles of claim 9, wherein the moiety comprises phosphorous.

11. A method for regenerative adsorption of moieties comprising at least one of phosphorous and arsenic, the method comprising:
contacting an aqueous stream comprising the moieties comprising at least one of phosphorous and arsenic, and doped goethite nanoparticles comprising iron and a different transition metal, wherein proportionally to iron, the different transition metal is present in the doped goethite nanoparticles in an atomic percentage range of 1% at to 20% at doping;
adsorbing the moieties comprising at least one of phosphorous and arsenic by the doped goethite nanoparticles;
recovering the moieties comprising at least one of phosphorous and arsenic from the doped goethite nanoparticles; and
regenerating the doped goethite nanoparticles.

12. The method of claim 11, wherein the moieties comprising at least one of phosphorous and arsenic further comprises at least one of phosphate, phosphite, arsenate, and arsenite.

13. The method of claim 11, wherein the moieties comprising at least one of phosphorous and arsenic is a phosphate comprising compound.

14. The method of claim 11, wherein the doped goethite nanoparticles are regenerated for at least 80% of an initial amount.

15. The method of claim 11, further comprising measuring a content of the moieties comprising at least one of phosphorous and arsenic in the aqueous stream.

16. The method of claim 15, wherein measuring the content of the moieties comprising at least one of phosphorous and arsenic precedes recovering the moieties comprising at least one of phosphorous and arsenic from the doped goethite nanoparticles.

17. The method of claim 15, wherein recovering and regeneration are performed when a content of the moieties comprising at least one of phosphorous and arsenic is higher than 50 μg L⁻¹.

18. The method of claim 11, wherein the doped goethite nanoparticles are embedded on a solid support.

19. A system for removal of moieties comprising at least one of phosphorous and arsenic from an aqueous stream, the system comprising doped goethite nanoparticles comprising iron and a different transition metal, wherein proportionally to iron, the different transition metal is present in the doped goethite nanoparticles in an atomic percentage range of 1% at to 20% at doping.

20. The system of claim 19, wherein the aqueous stream is a fresh water aqueous stream.

21. (canceled)

22. (canceled)
